(19) United States
(12) Patent Application Publication
(10) Pub. No.: US 2004/0061720 A1
(43) Pub. Date: Apr. 1, 2004

(54) Multi-function browser toolbar with method for online institutional administrative browser control

(76) Inventor: Matt Weber, Spring Hill, FL (US)

Correspondence Address: Matt Weber, OBC direct, 11654 Plaza America Drive # 335, Reston, VA, 20190, US

(21) Appl. No.: 10/437,487

(22) Filed: May 15, 2003

Related U.S. Application Data
(63) Continuation-in-part of application No. 10/254,591, filed on Sep. 26, 2002, now abandoned.

(51) Int. Cl. G09G 5/00

(52) U.S. Cl. 345/760

(57) ABSTRACT

A method and system for improving individual online usage through a multi-function Internet toolbar, and a system for an institutional online administration control allowing management of the toolbar interface for a group or a community of users utilizing the toolbar. The embodiments in the present invention include the ability for a user to search and toggle groups of online search engines specializing in a specific field; the enablement of a user to toggle highly structured static business portal content and information by professional category; the possibility for a user to shop online and earn shopping rewards directly from the toolbar with the reward amounts calculated and displayed on the toolbar; a provision for button-click access to login to online accounts; the enhancement of the user's browser background by allowing the user to add images provided by the invention or images designed by the user and selected from local computer files; the increase in the user's access to information by utilizing a resolution detection system in which the invention displays a set of toolbar buttons best suited for the user's resolution setting; and the empowerment of a professional through the control option to refresh the entire look and feel of the toolbar button, images, menus, content, search engines and browser background designed by professionals for professionals to meet the demands of a specific given field. Yet another embodiment provides an institution (i.e. businesses, federal, state or local government, university or other) with the ability to administer or fully manage and control the Business Navigator invention online, including but not limited to the button names, menu items, images, search engines and visual background display of the toolbar for employees, customers, or students, or any group or community of users.

### RELATED APPLICATIONS

Not applicable

### FEDERAL SPONSORED R & D

Not applicable

### FIELD OF THE INVENTION

This invention comprises a method of improving individual online usage through a multi function Internet toolbar. It includes a system for an institutional online administration control, allowing management of the toolbar interface for a group or a community of users utilizing the toolbar.

### BACKGROUND OF THE INVENTION

Internet browser toolbars commonly have been designed to allow users to make simple online searches or navigate button menus with links to Web sites from their browsers. In other words, toolbars make Internet navigation possible from a browser.

Examining prior art U.S. Pat. No. 2002/0057299 A1 describes a method for dynamically retrieving data and new images to a toolbar based on the user URL navigation. This dynamic retrieval of information works on a technically based relevance of the URL. The technology essentially guesses what the user wants to see, and the information retrieved is frequently not relevant or useful to the user. (For example, a user might wish to access his or her bank in order to pay bills. The dynamic toolbar retrieves and displays buttons and images containing banking information that is of no help to the user in paying his bills: it shows information on mortgages, on loans, on bank locations and special programs and information that is irrelevant to this particular user in this particular session of trying to pay bills. In fact, not only is the user sidetracked by much of what is displayed, but his or her time is wasted in navigating around the dynamic button menus.) Toolbars that work dynamically are constantly refreshing, thereby slowing both Internet connectivity and the browsers access function. Moreover, dynamic toolbars can be visually distracting, since the “look and feel change” with each URL. This technology can actually hamper the user rather than improve the user's ability to perform browser-based activities on the Internet. In addition, current technology lacks a control option to refresh or toggle new static content and images, or to search engines that would be relevant and useful to a particular user. Finally, some dynamic toolbars offer the ability to add browser backgrounds (commonly called skins), so that the user can customize and enhance his or her visual experience by using selected images as a background design to the browser. However, these toolbars require the user to use a Web page—the user cannot use his or her own images, only the ones permitted by the toolbar provider.

U.S. Pat. No. 2001/0044855 A1 titled, “A Method for the System of Facilitating On-Line Shopping Using an Internet Browser,” discusses a toolbar e-wallet, and in particular the checkout process. It lets a user enter personal data to a pre-established registration form, subsequently automatically filling out the merchant's checkout form. This method helps consumers check out while shopping online, but it lacks any function that would allow the user to earn cash back rebates or shopping rewards from the toolbar. Online rewards shopping has up until now only been accessible through cumbersome Web pages and via Web site-based shopping services. In other toolbars, users may find shopping menus with dynamic or static merchant menus but that again lack the ability for the user to earn cash back rewards directly from the toolbar (and access to a display of these earning on the toolbar itself).

U.S. Pat. No. 2002/0057299 talks about a mechanism that customizes, programs and packages a general browser specifically for a designated business Web site. It describes a work flow method of retrieving specifications from a client, customizing and packaging content, assembling diskettes and labels plus sleeves, and using mail or bulk mail to ship the product. This method is largely manual; it is slow and lacks control for the business once the product has been delivered. Further, U.S. Pat. No. 2001/0029527 A1 titled, “Method and System for Providing a Customized Browser Network” describes a dynamic technology used to display Internet data for only one end user. Again, it works on relevance-based technology that tries to retrieve data that it guesses might be useful to the user, deriving its guesses from a URL the user navigates or personal data the user provides. These technologies focus on providing dynamic information to only one user, and can only make guesses at what the user may be looking for online. This technology—which changes buttons and images, creates promotions and is running constantly and dynamically behind the user's browser—could be considered more problematic than useful to many Internet users. None of the above technologies provide highly controllable static personal information tools, or a remote administration control to allow one administrator to control the content of a community of users utilizing a toolbar.

### SUMMARY OF THE INVENTION

The Business Navigator browser extension invention puts together unique toolbar systems and methods. These include a search engine toggle switch, a portal toggle with controlled static information, reward shopping, account access management, professional browser interface option, and visual browser enhancement. It also provides businesses or institutions with an advanced and robust ability to administer the Business Navigator invention online. This includes (but is not limited to) the button names, menu items, images, search engines and visual background display of the toolbar for employees, customers, students or a community of users. The number of users is not limited. Additionally it provides a method for a unique system to best display the toolbar button images upon original download, based on the end user computer resolution setting. Finally, it provides a unique method for the user to uninstall and reinstall the toolbar with the same account data being retrieved. The Business Navigator invention's usefulness lies in the unique business methodology used for the toolbar features and in the institutional control provided over the Business Navigator invention for a group or community of users. Each method and system of the Business Navigator invention is broken out below in sections one through nine.

### BRIEF DESCRIPTION OF DRAWINGS AND FIGURES

FIGS. 1A to 1D show a graphical work flow of the search engine toggle method, where a user selects and toggles a new (group) of specialized search engines that are designed for searching pre-selected categories like Medical, Government and others.

FIGS. 2A to 2F show a graphical workflow of the business portal toggle method, in which a user selects the business portal and navigates professional portal menus. In the example shown, the user uses the toggle to switch to the programming portal to demonstrate how a user can navigate the professional programming portal menus.

FIGS. 3A to 3D show a graphical workflow of the rewards shopping method by first clicking a button to select category merchants. The (e) symbol to the left of the merchant's name indicates that the merchant is a participant in the rewards program. The user can select the merchant, shop online and receive a cash back rebate that is calculated and displayed on the rewards button on the toolbar.

FIGS. 4A to 4B show screenshots of two different versions of the toolbar button display via resolution detection in 800 by 600 and also 1024 by 768.

FIGS. 5A to 5I show a graphical workflow of the toolbar browser background method, in which the user selects a background from the toolbar options, applies an image designed and provided by the Business Navigator service, then applies an image designed by the user from the user's local computer. All of these actions are completed directly from the toolbar.

FIGS. 6A to 6F show a graphical workflow of the access management method, in which the user first selects toolbar options, then the login management tab, and finally selects a service and logs into the service (initially setting up the system by entering the username and password for the selected service). The user then clicks the login Mgt button on the toolbar, causing automatic login to the service selected.

FIGS. 7A to 7E show a graphical workflow of the toolbar reinstall and account retrieval method with the toolbar presently installed on the browser. It then shows the toolbar uninstalled, and finally the user retrieving the same account through the reinstall Web page, entering only the users registered username and password.

FIGS. 8A to 8C show a s graphical workflow and diagram of the professional browser interface option that allows an individual to select a browser category and refresh the entire browser interface (including the button names and images, menu names and items, search engine set, and browser background appearance) all of which are designed specifically for the profession of the individual and option category selected.

FIGS. 9A to 9B show diagrams of the institutional administration Web page and features, including a menu tree that controls the toolbars button and menu names and URLs, a button control that adds or removes images, a background control that adds and removes backgrounds, a search engine control that adds and removes search engines, and finally a “community of registered users” control page.

### DETAILED DESCRIPTION OF PREFERRED EMBODIMENTS

Section 1—Multiple Search Engine Toggle Switch Method

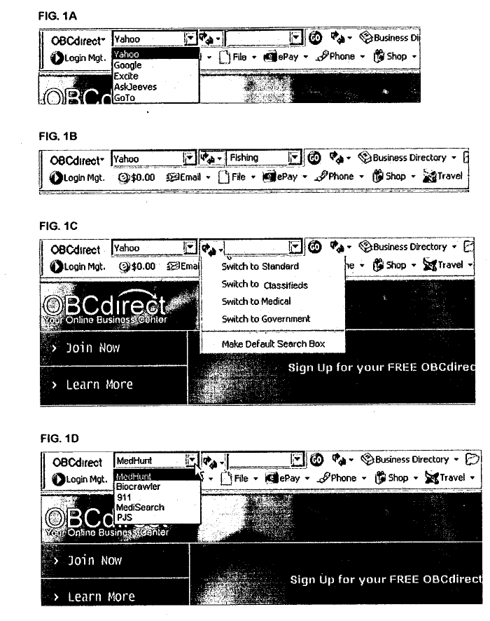

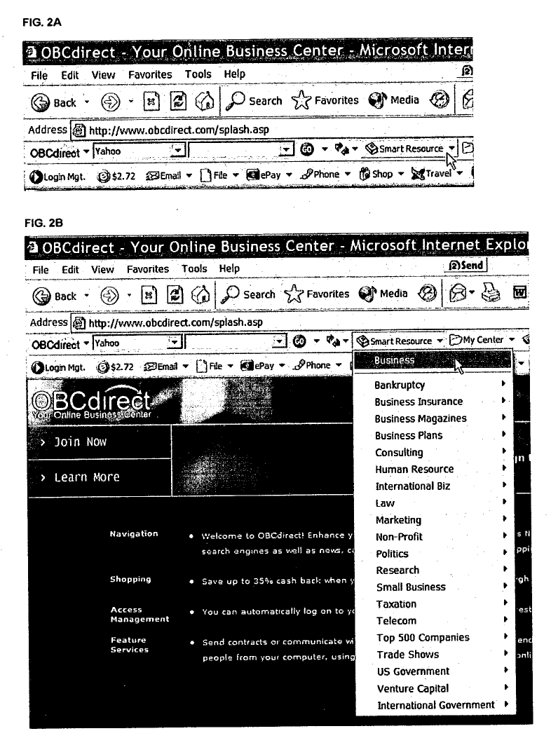

The primary advantage of the Search Toggle switch is that it allows the user toggle control in order to access multiple online categorized search engine services and search the services directly from the browser. This feature allows a user to toggle and switch access to a (group) of search engines specifically designed to perform targeted searches in specialized areas. After toggling, the user can select a specialized search engine and perform the search directly from the search box provided on the toolbar from the browser. (For example, a consumer may toggle the General search engine category, which allows the user to select and search a specific group of general search engines directly from their Internet browser. A consumer wishing to look up a person's address may want to toggle the Yellow Page category, which allows the user to select and search a specific set of search engines specializing in Yellow Page searches. A doctor may want to toggle the Medical category, which displays search engines specializing in medial searches directly form the Internet browser.) It is worth noting the usefulness of a search toggle that allows a professional to quickly access a group of specialized search engines and perform searches directly related to his or her specialized needs, and perform the search quickly and directly from within the Internet browser. A further enhancement is that the user can select and explore one search engine after another on the same topic to see the search results of the specialized search engines in that specific category. FIG. 1A is a screenshot of the invention showing a user selecting a search engine. FIG. 1B is a screenshot of the invention showing a user typing the word “fish” in the search term field and clicking GO. The feature calls the search engine and displays the search results within the browser window. FIG. 1C is a screenshot of the invention showing a user accessing the search toggle switch and selecting the Medical category. FIG. 1D is a screenshot of the invention showing a new (group) of specific medical search engines (MedHunt, Biocrawler, and 911) designed for searching medical related items appearing in the search engine box. The user can select any search engine from the new list, perform a specific search and receive search results as explained above.

Section 2—Business Portal Toggle and Information Method

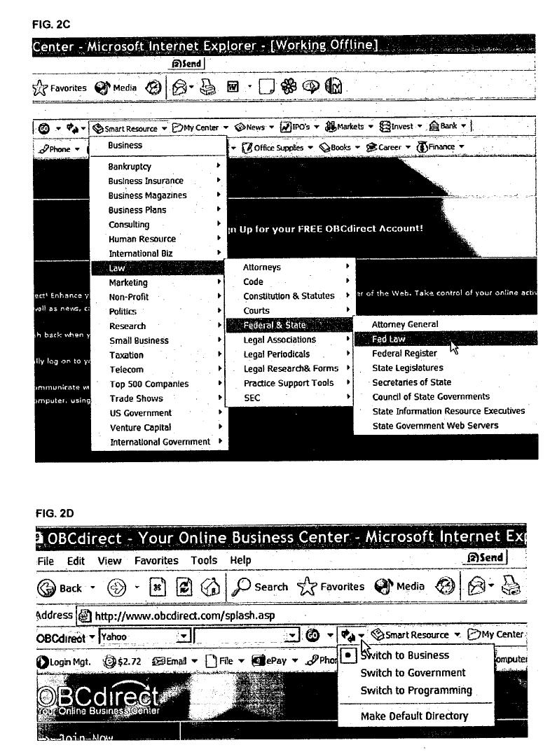

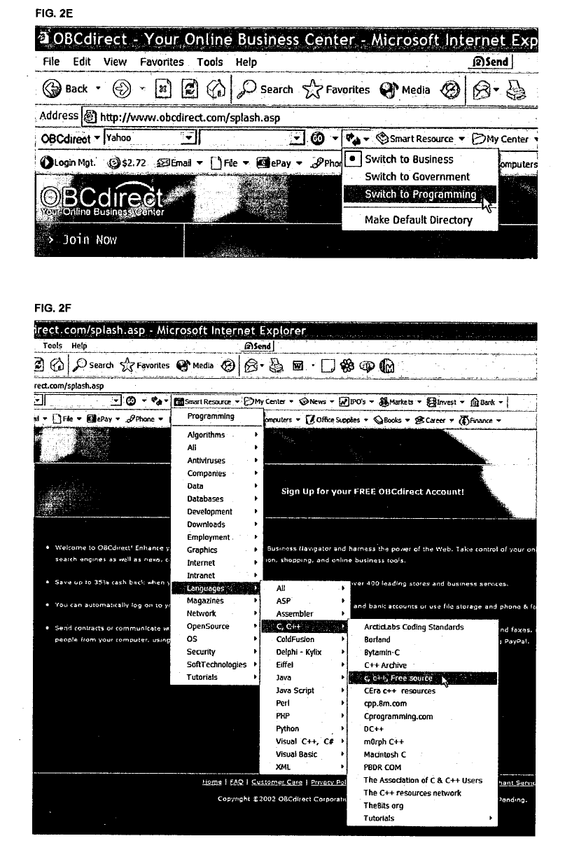

The Business Portal Toggle method is not dynamic technology but controlled static informational content, compiled and categorized by professionals for professionals in related fields. The information is highly relative. The invention allows professionals to select and toggle specific portal content that is similar in nature to content provided from two or three comprehensive Web-based portals. The user can access and navigate this information directly from an Internet browser. The toggle allows a user to select, view and access specific portal information directly related to that user's line of work or field of interest. (For example, a programmer may toggle the Business Navigator's programming portal, which displays highly specific aggregated Internet information for a professional programmer. A business owner may toggle the business portal, which displays highly specific aggregated Internet information and services for a professional businessperson.) The consumer thus has quick and easy access to highly specific information related to their direct interest with point-and-click navigation control from their browser. The static content can only be changed by a remote professional administrator of the toolbar, rather than the end users, and will not change through the dynamic navigation of URLs. Therefore it does not visually hamper the user by “guessing” what information the user wants and then constantly changing what it displays. Rather, this invention allows the user to choose what is displayed on his or her browser. Moreover, the portal categories are unlimited. They can be medical, programming, government, business, accounting, legal, education, military—or anything that the user wishes them to be, which is a tremendous asset to the user. The following figures are all screenshots taken of the invention itself. FIG. 2A shows a user selecting the business portal directory button. FIG. 2B shows the business portal directory menu topics. FIG. 2C shows the user navigating the business portal directory menu topics and menu links. FIG. 2D shows the user selecting the portal toggle and a sample of the unlimited selection of the professional portal options. FIG. 2E shows the user selecting the portal toggle. In this example, the user is toggling the programming portal. FIG. 2F shows the toggle switching the portal to programming, allowing the user to navigate through a professional aggregation of programming information. It is important to note that the button image also changes with the toggle of the portal. The images change to represent the portal chosen and give the user a visual cue so that he or she knows that the toggle is set to the desired portal. The toggle can also be set to Default, which will maintain the desired portal at all times including after the user opens and closes the browser.

Section 3—Rewards Shopping Method:

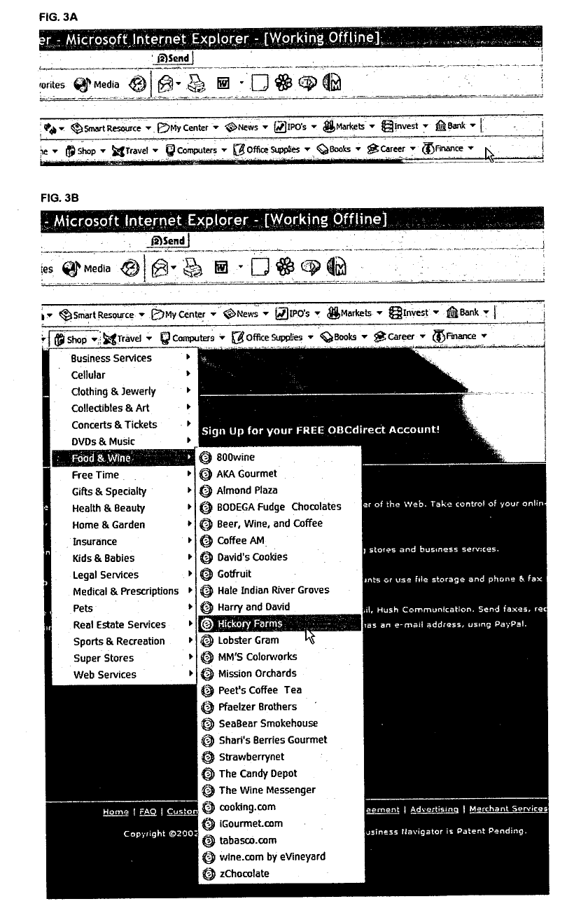

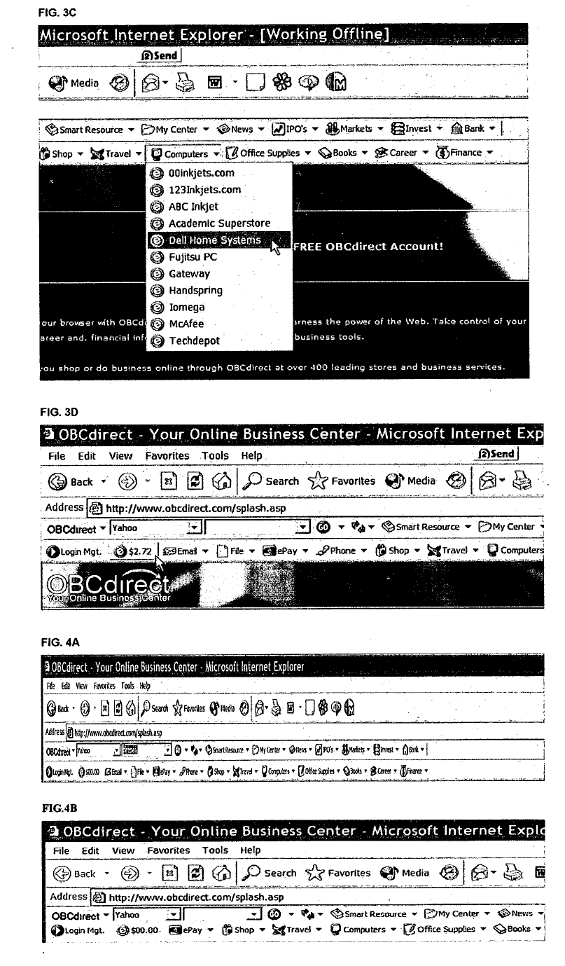

With the Business Navigator invention consumers can navigate, select merchants, shop and earn shopping rewards directly from their Internet browser. The primary advantage of the Business Navigator invention is the ability for the user to earn cash back shopping rewards and earn rebates directly from their Internet browser. It allows the user to see rewards earned, calculated, registered and display directly on the toolbar browser. The shopping menus provide the user with a unique identifier of either a symbol or a rebate percentage that indicates the merchant is within the rewards infrastructure on the menus of the toolbar. To get a better understanding and appreciate the rewards shopping method figures have been assembled. FIG. 3A shows the Shop, Travel, Office Supplies, Books, Career, and Invest toolbar shopping buttons. FIG. 3B shows a user selecting first shopping categories, then the Food & Wine category, and finally the merchant (Hickory Farms). Note the (e) symbol found to the left of the merchant name, which is used to identify the merchants taking part in the cash back rewards shopping feature. FIG. 3C shows how the user can select different shopping menus and buttons (such as Computers) directly from the browser toolbar while identifying the merchants with (e) symbol that are participants in the cash back rewards shopping feature. FIG. 3D shows the rewards button location on the toolbar where the user finds the total cash back rebates aggregated from his or her online shopping. The rewards are later distributed to the user.

Section 4—Resolution Detection and Browser Button Visual Display Method:

Resolution detection is used in displaying the Business Navigator invention. When the user registers and downloads the Business Navigator, the user's resolution setting is detected and the Business Navigator that is downloaded is designed specific for the resolution setting of the user. It allows the user to see the best visual display of static buttons and images for his or her computer's resolution, providing the user with the most convenient access to information.

The Business Navigator invention provides the user with the best image and data display that is possible based on the users resolution setting on his or her computer. For example, a user with a higher computer resolution will receive the Business Navigator invention with more buttons displayed. For users with lower resolution, fewer buttons will appear. In this example, it is important to note that the data is not lost; it is still stored under the buttons that do not appear in lower resolutions. The data is re-set within the appropriate menus of the buttons that are showing on lower resolution screens. This means the user still has one-click visual access to information. Some toolbars use chevrons, and put the buttons that do not fit on the users screen under the chevron. The Business Navigator invention uses chevrons as well, but none of the Business Navigator invention toolbar buttons display in the chevron. Buttons move to the chevron only when the user minimizes the browser screen. To better understand and appreciate the invention, the following figures provide samples in 800 by 600 and 1024 by 768 resolution. These resolutions are commonly used resolution settings, though the process being discussed is not limited to these resolutions. FIG. 4A shows a button display in 1024 by 768. The reader can see buttons such as Invest, Bank, IPO's, Email and File on the toolbar. Higher resolution users can see more buttons displayed, thus gaining better visual access to information for the users resolution setting. FIG. 4B shows button display in 800 by 600. The reader can see that the buttons Invest, Bank, IPO's, Email, and File have been removed from the toolbar. The information from the missing buttons is reset within appropriate button menus. For example, the information contained in Bank and Invest found in the 1024 resolution toolbar are now within the Market button menus on the 800 by 600 resolution toolbar. This allows the user to have all information available from buttons viewable on the toolbar. It keeps buttons and information from being shifted to a chevron that hides the buttons and the information, making them more difficult for the user to access.

Section 5—Browser Background Method:

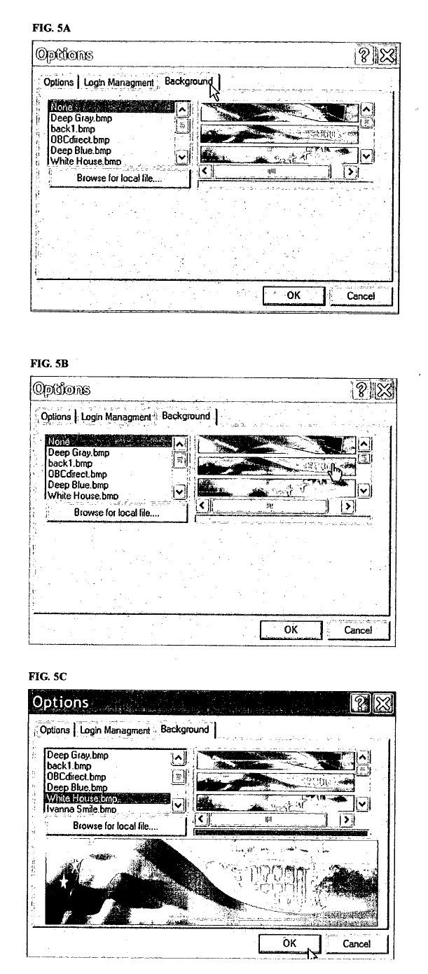

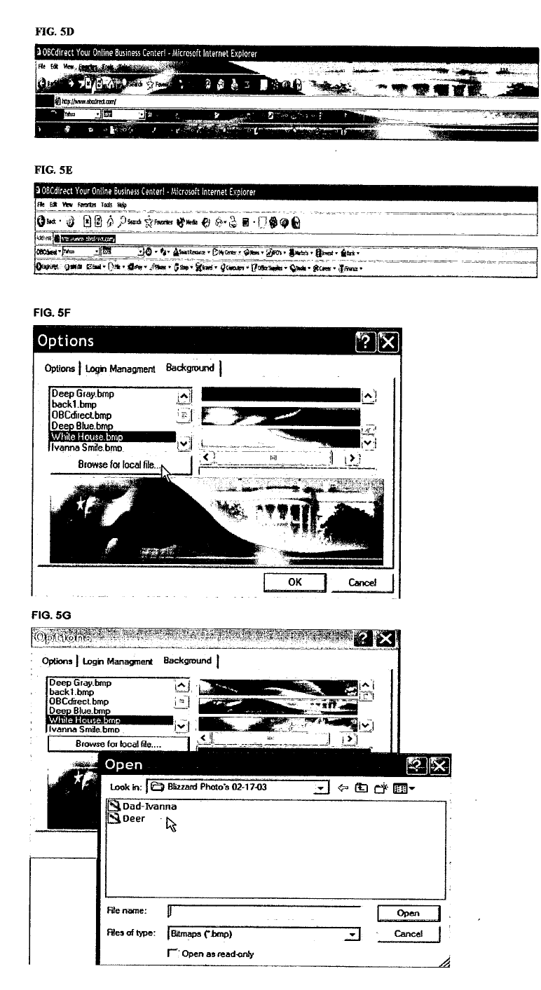

The Business Navigator invention allows users to add custom designed browser backgrounds but, unlike other products, it uses a uniquely easy mechanism directly within the browser extension options. In addition, the Business Navigator invention allows the user to add his or her own custom pictures from files saved on a personal or business computer. Pictures of pets, families, company logos or headquarters—any picture can be used as a browser background, no matter what format (bmp, jpeg, gif, etc.) has been used to save the image. This is all done internally from the browser extension; no Web page or special format is required. The user simply selects options from the browser extension menu, clicks the background tab and selects a thumbnail that is downloaded from a server. Users also have the option to browse from their local files. From here, the user can select any image from the computer and add it as a browser background. This is a simple operation that is quick and painless, particularly as opposed to needing to know the sizing or technical operation of adding a local browser image to the browser background. To better understand and appreciate this browser background method, the following figures have been arranged to dearly demonstrate the system. FIG. 5A shows a user selecting the background tab from browser extension options menu. FIG. 5B shows the user viewing thumbnail pictures provided by the Business Navigator invention and clicking to download a selected image. FIG. 5C shows that the user has downloaded and highlighted the image titled “White House.bmp.” The user clicks OK to apply the image to the browser background. FIG. 5D shows the White House image applied to the browser background. FIG. 5E shows another style and sample of image, Swirl Gray, applied to the browser background. FIG. 5F shows a user clicking to Browse Local files. Note again that this invention allows the user to select and apply his or her own image in any bmp, gif, jpeg or other image format. FIG. 5G shows a user viewing local image files. FIG. 5H shows a user, having selected a local “Deer” image, now highlighting the file. The user clicks OK to add the “Deer” image to the browser background. FIG. 5I shows the user has applied the custom “Deer” image to the browser background.

Section 6—Access Management Method:

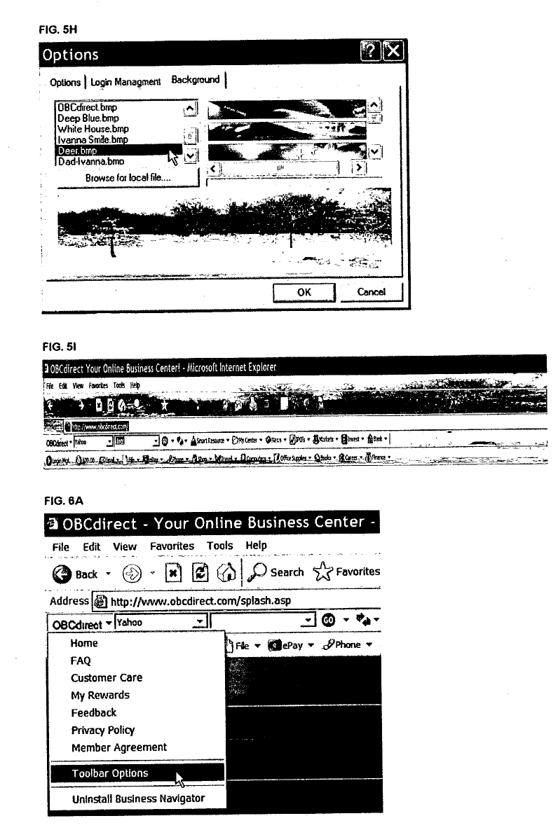

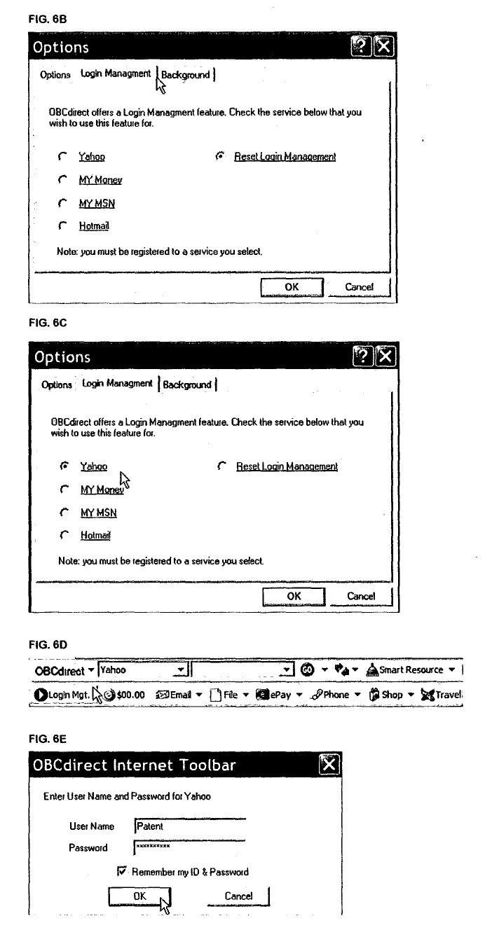

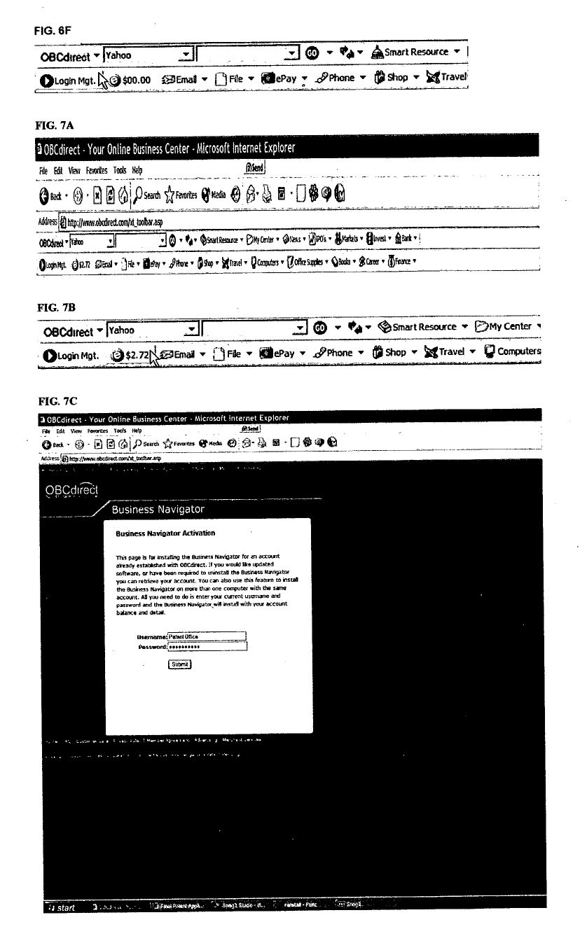

The Business Navigator Access Management feature allows consumers to access online accounts conveniently from one-button dick control on the toolbar. The primary advantage is the consumer can click the access management button on the toolbar and be logged In automatically to services. This method gives the user point-and-click login access. The user does not need to pull the button menu down to locate or select a service. To better understand and appreciate the advantages of this method, the following screenshots of the invention are available by way of illustration. FIG. 6A shows the user selecting toolbar options under the OBCdirect button menu. FIG. 6B shows the user selecting the Login Management tab on the toolbar option menu. FIG. 6C shows a user selecting a desired service. FIG. 6D shows the user clicking the Login Mgt button on the browser toolbar FIG. 6E shows the user entering the username and password for the service selected. At this point, the user has the option to check Remember My ID & Password, or leave it blank. If the user chooses to check Remember My ID & Password, then the user simply clicks the Login Mgt Button on the browser extension and the feature will automatically call the page and login to the service with no other effort than clicking the button. If the user does not select the service to remember the information, the User Name/Password box will appear each time that the Login Mgt button is clicked. This feature can be useful in the event that more than one person accesses the same machine. FIG. 6F shows how the user can login directly to online services by clicking the Login Mgt. button on the browser extension at any time or location on the Internet.

Section 7—Toolbar Reinstall and Account Retrieval Method:

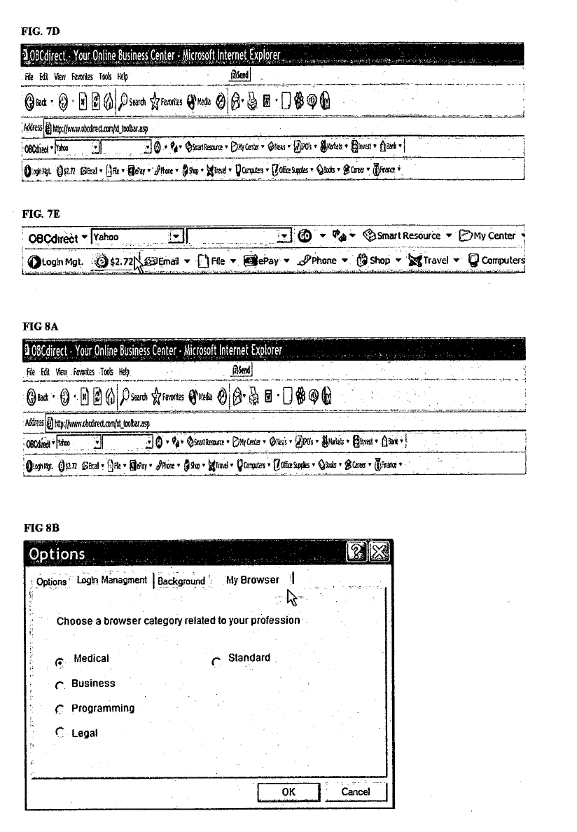

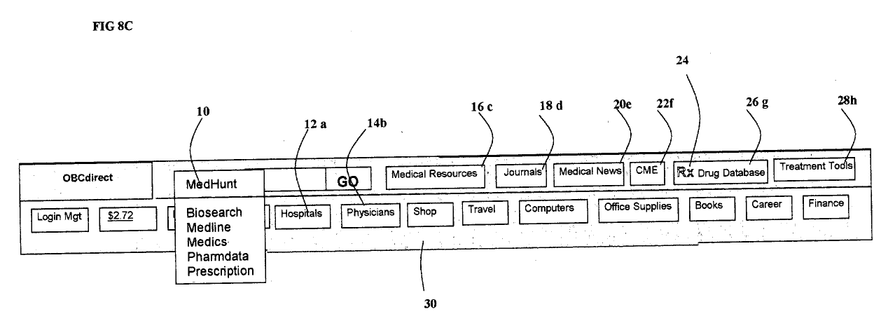

This exceptional process allows a user that registers and downloads the Business Navigator toolbar invention the ability to uninstall the toolbar and then reinstall a new toolbar—retrieving the user's same account data and any shopping rewards associated with that account ID. This can be used if the user has more than one computer on which to install the Business Navigator and would like to maintain one account. It would be equally useful in the event that the user's computer experienced problems or system crashes with a resulting loss of the software running the Business Navigator. The system works by allowing the user to navigate to a reinstall toolbar Web page, where the user enters his or her registered username and password. The system then checks the database and retrieves the account data associated with that account ID. It then allows the user to download a new version of the Business Navigator toolbar, maintaining the same account profile and shopping reward data. All of this is illustrated in the screenshots of the invention that follow. FIG. 7A shows the Business Navigator toolbar presently installed on the browser. FIG. 7B shows the user's $2.72 shopping rewards balance associated with the user's account. FIG. 7C shows that the present toolbar has been uninstalled and removed from the browser. It also shows the reinstall Web page, with the user being required only to enter the registered username and password on the page to retrieve the account. FIG. 7D shows that the user has reinstalled his or her username and password and maintained the same account. FIG. 7E shows that the user has retrieved the same $2.72 rewards balance that was held before the toolbar was uninstalled.

Section 8—Professional Browser Interface Method:

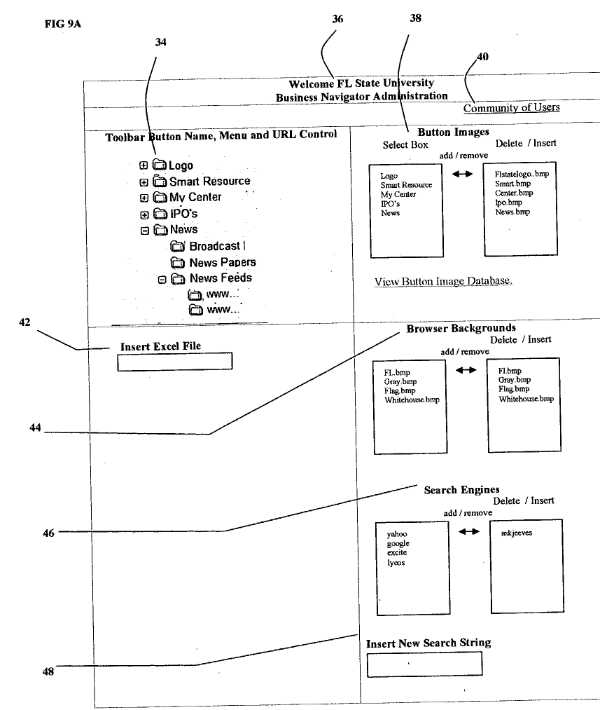

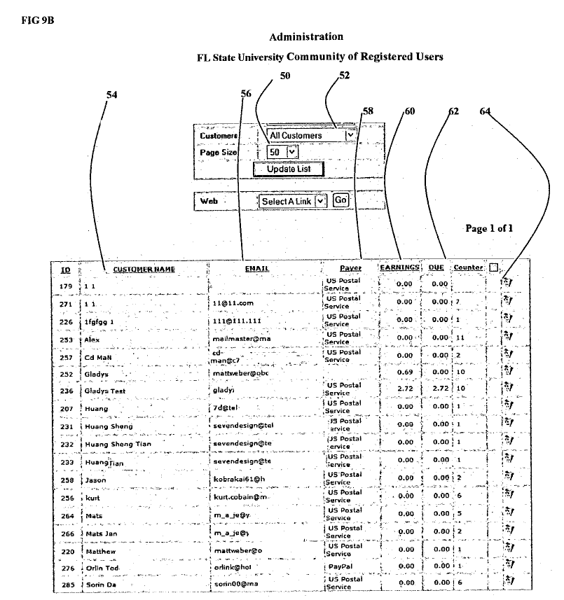

This business application is unique in that it allows professionals to select a specifically tailored static browser layout for their individual professional requirements. The user can choose any desired browser layout from the toolbar options menu. Utilizing a XML file stored on a server and not a database, the toolbar will then completely refresh the browser with highly aggregated static information specifically designed for professionals by professionals. Once the user has chosen which browser layout option to implement, the toolbar will display a completely new set of buttons and menu names and images, a new group of search engines, new menu content and a new browser background to suit the professional category selected. These options were specifically designed for the each discrete professional interface. The user can choose from options such as Medical, Programming, Government, Legal, Accounting, Education, Military, and other industrial and professional options, completely updating the browser content, functions, and the look-and-feel. The browser refresh method is not dynamic relevance based database technology, but rather all of the new button images, menu content, search engines and browser backgrounds are statically-controlled XML files compiled by professionals who understand the interface option selected by the user. The content and look-and-feel is highly relevant and useful to the individual requiring that professional interface option, and users have a choice as to what they would like to see on their browsers. FIG. 8A shows the standard Business Navigator invention. FIG. 8B shows the options menu, where a user can select and choose a browser interface. This particular screenshot shows the user selecting the Medical option under the My Browser tab. FIG. 9C shows a diagram of the standard toolbar layout refreshing itself as the user moves from the medical option under the My Browser tab to the new Medical layout and toolbar display. Arm 10 shows an example of a new set of medical search engines being completely changed. Arms 12a to 28h show new titles on the toolbar buttons that contain all new menu names and are content-specialized for medical professionals. Arm 24 shows an example of a new image appearing on the button. Arm 30 shows an example of how the background of the browser will change, moving in this case to a new medical blue background color.

Section 9—Online Institutional Administrative Control System:

This distinctive feature to the invention and system allows businesses, federal, state and local government, universities or other institutions complete control over the informational content, look and feel of the Business Navigator invention browser extension and of the browser. It gives authorized administrators the power to control, manage and update—at any time—the informational content displayed on any individual's browser within a community of interest. This is done completely online. The feature allows customization to meet the specific informational demands of internal staff, external customers, students or other institutional needs. No personal physical interaction is required other than a utilization of the administration control module on a Web page

An administrator accesses the feature through an online Web interface that controls the browser extension, including but not limited to the buttons, menus, links, search engines and images that appear on the end user's browser. The service uses an online administration tree-based menu interface to edit the name and add or delete toolbar buttons, menus and content. It also allows administrators to add or remove button images and add browser backgrounds and search engines. Each company or organization is assigned an ID stored inside a database. The organization is given a special online URL or link associated with that ID. The ID allows the institution's customers or employees to download a customized version of the Business Navigator invention that contains all of the specific data the organization has assembled directly into their browser. The content, including the URLs for the toolbar menus, images and other data, is stored within the a server file menu structure tracked against the institution's ID. Content assembled by the institution can be associated with the institution's Web site, or it can be any content on the Internet that it would like As community of users to see. The institution has total control over the content and look-and-feel, and can login to the administration Web site and edit or make changes at any time. Once the administrator makes changes or updates content, the new material will automatically appear in each browser toolbar belonging to the customers, employees or community of institutional users. The community can be large or small; the number of people using toolbar is not a factor.

The invention has features for three different business markets and incorporates the rewards shopping component. The invention is separately broken out to show specific unique features that can be used for different market segments in order to demonstrate the uniqueness and usefulness of the invention.

The first manner in which the invention can be used is in allowing an organization or business to empower their customers and develop a new revenue stream. This feature is targeted toward Internet-based businesses that would like to enhance their Web sites' usability and add a unique feature such as the Business Navigator invention to their site. It enables these organizations to co-brand and resell the Business Navigator invention to their own audience of customers and receive 50% of all rewards shopping profits generated. This service allows online administrative control of Business Navigator invention buttons and menus to customize the look, feel, and informational content toward their specific target market and customer base. It allows the organization to add their own Web site links and any other Internet content targeted toward their customer base right into the browser extension menus for quick and easy access for their customers.

The second way in which the invention could be used is in allowing an organization to empower their employees, and aggregate and save on their company's online purchasing. This feature enables small businesses to co-brand and customize the Business Navigator's buttons, menus and informational content. They can add their own online directories, Web content, or internal organizational links. This feature aggregates their entire employees' online purchasing, allowing the company to receive the online shopping rewards. Many companies currently lose large amounts of shopping reward-based incentives because of employees purchasing products individually and being reimbursed via company expense accounts. (For example, if an executive purchases an airline ticket and is later reimbursed by the company, the executive receives the frequent flyer miles personally rather than those frequent flyer rewards being distributed to the company that actually paid for the service.) The Business Navigator invention and this administration feature option allows employees to purchase items online on behalf of the company, and the shopping rewards are aggregated and sent directly to the company that paid for the purchases.

The third manner in which the invention could be used is in allowing an organization to create its own browser enhancement from scratch. This feature enables organizations to develop their own browser extension from the ground up. It allows them to develop a blank set of buttons and menus to add their own online directories, Web content, internal corporate links, images, backgrounds, search engines or any other Internet information, all within an easy-to-use online administrative control page.

To get a better understanding and appreciate the institutional administration aspect of the invention, the following figures will be helpful. FIG. 9A is a diagram of the administrative Web page and its multiple functions. Arm 36 shows the title and name of the institution that has logged on to the administrative control page. Arm 34 shows a menu tree that controls the toolbar button and menu names and also the menu URLs. An administrator can click the menus open to change the text name or menu URL. Arm 42 shows a box that allows an administrator to upload a pre-developed Microsoft Excel file. This could be used in the event the administrator has arranged for up to thousands of URLs to be added to the toolbar buttons or menus. Arm 38 shows where the administrator can insert his or her own custom buttons and images, and add plus remove them from the toolbar. The View Button Images database also allows the user to choose from a pre-established button image database. Arm 44 shows the section in which the administrator can insert his or her own custom browser backgrounds or add and remove them. Arm 46 shows the section in which the administrator can add or remove search engines from the toolbar. Arm 48 shows a box where the administrator can add any search engine string on the Internet, and the search engine will then be add to the toolbar. Arm 40 show the Community of Users link, which links to the administration control page allowing the administrator to monitor and control the users who have downloaded the customized toolbar. FIG. 9B shows the administrative community of registered users control page, which lets the administrator monitor and control the users who have downloaded the customized toolbar. Arm 54 shows the users name and ID. Arm 56 shows the user's e-mail address. Arm 58 shows the form of rewards payment that may be associated with the user or the organization. Arm 60 shows the earnings that may be associated with the user. Arm 62 shows the rewards balance that may be due to the user or institution. Arm 64 shows the delete option the administrator can control to delete a user from the database. Arm 50 allows the administrator control over the number of users to be displayed on the administrator's computer screen. Arm 52 allows the administrator the option to view inactive or active users.

I claim:

1. A method for improving online usage by providing a multi-function Internet browser toolbar plug-in to be installed in the browser of a Web surfer and comprising:
a. a search engine toggle means for toggling select groups of online search engines specializing in a specific field;
b. a portal toggle means for toggling select professional categories of highly structured static business portal content and information uniquely identifying itself;
c. a shopping rewards method means for shopping online and earning shopping rewards directly from the toolbar with the reward amounts calculated and displayed on the said toolbar,
d. a resolution detection system means for detecting computer resolutions to display the best toolbar button visual layout automatically upon download;
e. a browser background method means for adding browser backgrounds from a local machine or select determine image files;
f. an access management method means for which access to online accounts can be made with one button click from the aforementioned toolbar,
g. a toolbar reinstall method means for account retrieval and installation of new toolbar;
h. a professional browser interface means for a control option to refresh the entire look and feel of the toolbar buttons, images, menus, content, search engines and browser background to meet the demands of specific given fields.

2. a system for a Web-based toolbar control module comprising:
a. an online Web-based control module system means for which an organization can control and manage the aforementioned toolbar button names, menu names, button images, and browser background images and search engines for a group or community of unlimited users;
b. an online Web-based community of registered users control module supporting the aforementioned administrative control module means for monitor and controlling the registered user accounts.
